(19) United States
(12) Patent Application Publication
(10) Pub. No.: US 2005/0176372 A1
(43) Pub. Date: Aug. 11, 2005

(54) Highly integrated reliable architectural radio system for maritime application

(75) Inventors: Gerald H. Nesbit, Reston, VA (US); Henry P. Altemus, Vienna, VA (US)

Correspondence Address: GRIMES & BATTERSBY, LLP, 488 MAIN AVENUE, THIRD FLOOR, NORWALK, CT, 06851, US

(73) Assignee: Wheat International Communications Corporation

(21) Appl. No.: 10/773,871

(22) Filed: Feb. 5, 2004

(51) Int. Cl. H04B 7/00

(52) U.S. Cl. 455/41.2; 455/129; 455/269

(57) ABSTRACT

A wireless unlicensed band radio system for use in maritime applications is provided comprising three sector antennas providing a minimum of 120 degrees coverage (3 dB point) which combine to achieve 360 degrees of continuous coverage. Each antenna has its own amplification path so as to improve the performance of the communication link. The system can use any commercially available unlicensed band radios, which typically have only two RF ports (primary and secondary). In order to incorporate the three antenna signals, a passive two-way power divider is incorporated in the primary port to provide driving signals to two of the three antennae. The secondary port is connected to the third antenna. A solid state transmit and receive amplification unit is incorporated in each of the antenna paths, which serves to amplify the signal and switch between transmit and receive operations. All of the sector antenna, amplification units, unlicensed band radio and DC power conditioning circuitry are enclosed inside an environmentally sealed radome, which offers protection against the harsh saltwater environment and direct solar loading, thus minimizing component failure due to saltwater exposure and excessive thermal stress. The system also utilizes CAT-5 cable for data connection which cable does not have the distance limitation of conventionally used coaxial cable.

### BACKGROUND OF THE INVENTION

1. Field of the Invention

The present invention relates generally to an unlicensed band wireless radio system for maritime use and, more particularly, to a highly integrated reliable broadband maritime radio system comprising three sector antennas providing a minimum of 120 degrees coverage (3 dB point) each which combine to achieve 360 degrees of continuous coverage. The present invention architecture is not limited to only three sector antennas configuration. For other sector configuration, the required horizontal angular coverage of each sector antennas is determined by dividing the 360 degrees by the number of sectors. In theory, there is no limitation to the number of sector antennas that can be deployed; however, practicality in the implementation will limit the number of sectors. For the simplicity of explaining the present invention, three sectors antenna radio system configuration will be discussed from here onward. Each antenna has its own amplification path so as to improve the performance of the communication link. A passive two-way power divider is incorporated in the primary radio frequency (RF) port to provide driving signals to two of the three antennas. The secondary RF port is connected to the third antenna. In the case for the four sectors antenna configuration, a second power divider can be incorporated in the secondary RF port to provide driving signals to third and fourth antennas. A solid state transmit and receive amplification unit is incorporated in each of the antennas paths, which serves to amplify the signal and switch between transmit and receive operations. The sector antennas, amplification units, unlicensed band radio and DC power conditioning circuitry are enclosed inside an environmentally sealed radome, which offers protection against the harsh saltwater environment and direct solar loading, thus minimizing component failure due to saltwater exposure and excessive thermal stress. The system also utilizes commercially available CAT-5 cables for both the network and the serial connections, which does not have the typical short distance limitation of conventionally used coaxial cable. The CAT-5 cable offers cost, size, weight, and ease of implementation over the conventional coaxial cable.

2. Description of the Prior Art

The conventional method for deploying outdoor unlicensed band radio system e.g., 802.11xx equipment, for the maritime applications would be to install an outdoor unit (antenna with amplification device) on a tall mast and an indoor unit (radio, network connection, and power source) inside a controlled environment, such as the cabin of a boat. The critical RF connection between the outdoor unit and the indoor unit is typically provided by an expensive and heavy coaxial cable to minimize the signal propagation loss.

Since the length of the coaxial cable run has a direct impact to the performance of the wireless radio system, it is usually limited to the maximum distance of 100 feet or less. If the distance separation between the outdoor unit and the indoor unit required to be greater than 100 feet, a more expensive and larger coaxial cable must be used. For many of the larger size boats, the distance between the placement of the outdoor unit and the indoor unit easily exceeds 100 feet. Also in many cases, the larger size cable is not feasible, since the conduit on majority of the boat is already filled with other DC and control cables and may not have sufficient room to accommodate the larger size cable.

The most common method for implementing continuous 360 degree coverage in the current unlicensed band wireless radio system is typically provided by an omni directional antenna coupled with a bi-directional amplification unit. If either the antenna and/or the amplification unit are defective, the entire wireless radio system will be lost completely. The other disadvantage of using only the omni directional antenna for continuous 360 degree coverage is in the area of radio system performance. In the unlicensed band, there are many unwanted and undesired interference frequency sources which can severely impact the system performance. The wireless radio system using only the omni directional antenna is susceptible to such interference sources and offers no protection against it.

Several recently filed applications and issued patents disclose technology relating to wireless radio systems and wireless networks. For example, U.S. patent application Ser. No. 20030120826 which was filed by Shay and published on Jun. 26, 2003 for “System and method for building a communication platform for the telematics domain using a distribution of network objects” discloses a system for enabling Wireless Wide Area Network communication capable of aggregating and disseminating information for the Telematics domain, without the need of additional external network infrastructure, such as communication towers and central switch.

Similarly, the use of multiple antennas has been disclosed in the prior art. For example, U.S. Pat. No. 6,597,325, which issued to Judd, et al. on Jul. 22, 2003 for “Transmit/receive distributed antenna systems” discloses a distributed antenna device including a plurality of transmit and receive antenna elements, and a plurality of power amplifiers. At least one of the power amplifiers is a low noise amplifier and is built into the distributed antenna device for receiving and amplifying signals from at least one of the receive antenna elements. A similar use of multiple antennas, for use in connection with a laptop, is disclosed in U.S. Pat. No. 6,531,985, which issued to Jones, et al. on Mar. 11, 2003 for “Integrated laptop antenna using two or more antennas” which describes the use of an integrated antenna array comprising multiple antennas within a digital device case to avoid the disruption in the radiation pattern that laptop components have on standard antennas.

The use of an antenna array for cellular or local area networks is disclosed in U.S. patent application Ser. No. 20030071761, which was filed by Judd and published on Apr. 17, 2003 for “Antenna Structure and Installation.” The application discloses a distributed antenna array having a plurality of antenna elements and a plurality of power amplifiers, each power amplifier being operatively coupled with one of the antenna elements and mounted closely adjacent to the associated antenna element, such that no appreciable power loss occurs between the power amplifier and the associated antenna element. Each power amplifier is a relatively low power, relatively low cost per watt linear power amplifier chip.

Furthermore, the use of antennas in maritime applications has also been disclosed in the prior art. For example, U.S. Pat. No. 6,102,758, which issued to Smith, et al. on Aug. 15, 2000 for “Near shore spar communication platform” discloses a semi-stable platform for data collection and retrieval for distances up to and over several miles offshore comprising an ocean-going computer housed in a modified spar buoy which is connected to a shore computer via a wireless Ethernet LAN. Similarly, the use of a wireless network in aircraft is disclosed in U.S. patent application Ser. No. 20030009761, which was filed by Miller and published on Jan. 9, 2003 for “Mobile wireless local area network and related methods.” The Miller application discusses a wireless local area network adapted for use by users traveling on a mobile platform such as an aircraft, including a network server located on the mobile platform, and at least one network access point connected to the server and accessible wirelessly by at least one user portable electronic device over one of a plurality of non-overlapping network frequency channels. The RF characteristics of this wireless network are specifically tailored to meet applicable standards for electromagnetic compatibility with aircraft systems and RF exposure levels for passengers and flight crews.

Similar technologies are disclosed in a number of additional applications dealing in the fields of multiple antenna arrays and wireless networks. For example, U.S. patent application Ser. No. 20030122714 which was filed by Wannagot, et al. and published on Jul. 3, 2003 for “Variable gain and variable beamwidth antenna” discloses a variable gain and variable beamwidth antenna including first and second antenna elements and an antenna element orienter for selectably varying the relative physical orientation of the antenna elements, thereby selectably varying the gain and beamwidth of the antenna.

Another such example is U.S. patent application Ser. No. 20030078075, which was filed by McNicol and published on Apr. 24, 2003 for “Omni transmit and sectored receive cellular telecommunications network and method of operating the same,” which describes a cellular radio telecommunications system including a base transceiver station for radio communication with a mobile terminal over an air interface. The base station includes at least a first and a second antenna device adapted for providing radio coverage over a first and a second sector of a cell wherein the combined geographical area of the sectors covers an angle of substantially 360 degrees. A transmitter unit and a receiver unit are also provided.

As will be appreciated, none of these prior patents even address the problem faced by applicant let alone offer the solution proposed herein. There exists a need for a wireless fidelity radio network system for maritime applications that is both reliable and capable of providing coverage regardless of the orientation of the craft or vessel.

### SUMMARY OF THE INVENTION

Against the foregoing background, it is a primary object of the present invention to provide a highly integrated reliable architectural radio.

It is another object of the present invention to provide such a wireless unlicensed band broadband radio system for use in a maritime environment.

It is yet another object of the present invention to provide such a wireless radio network capable of providing continuous coverage regardless of orientation.

It is still another object of the present invention to provide such a wireless radio network that includes at least three antennas each capable of providing a minimum of 120 degrees of coverage which combine to achieve 360 degrees of coverage.

It is another object of the present invention to provide such a wireless radio network that allows for continued communication and maintenance of the communications link in the event there is a failure in one of the amplification units.

It is another object of the present invention to provide such a wireless radio network that offers some degrees of immunity from the unwanted and undesired frequency interferences by controlling signal propagation through the panel antennas.

It is still yet another object of the present invention to provide such a wireless radio network in which the components are securely enclosed within an environmentally sealed structure for protection against the harsh saltwater environment.

It is another object of the present invention to provide such a wireless radio network which utilizes cable that does not have the distance limitation of conventionally-used coaxial cable for connecting the indoor and the outdoor units and greatly enhanced its system performance.

It is but another object of the present invention to provide such a wireless radio network which eliminates the needs for the heavier, larger size and expensive coaxial cable to interconnect the outdoor and the indoor units.

It is still another object of the present invention to provide such a wireless radio network which simplifies the installation of the wireless radio system for maritime applications.

To the accomplishments of the foregoing objects and advantages, the present invention, in brief summary, comprises a unlicensed band radio system for use in maritime applications comprising three sector antennas providing a minimum of 120 degrees coverage (3 dB point) which combine to achieve 360 degrees of continuous coverage. Each antenna has its own amplification path so as to improve the performance of the communication link. The system can use any commercially available unlicensed band radios (e.g. 802.11b), which typically have only two RF ports (primary and secondary). In order to incorporate the three antenna signals, a passive two-way power divider is incorporated in the primary port to provide driving signals to two of the three antennae. The secondary port is connected to the third antenna. A solid state transmit and receive amplification unit is incorporated in each of the antenna paths, which serves to amplify the signal and switch between transmit and receive operations. All of the sector antenna, amplification units, unlicensed band radio and DC power conditioning circuitry are enclosed inside an environmentally sealed radome, which offers protection against the harsh saltwater environment and direct solar loading, thus minimizing component failure due to saltwater exposure and excess thermal stress. The system also utilizes CAT-5 cable for data connection which cable does not have the distance limitation of conventionally used coaxial cable.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a schematic illustration of the wireless radio system of the present invention.

### BRIEF DESCRIPTION OF THE PREFERRED EMBODIMENTS

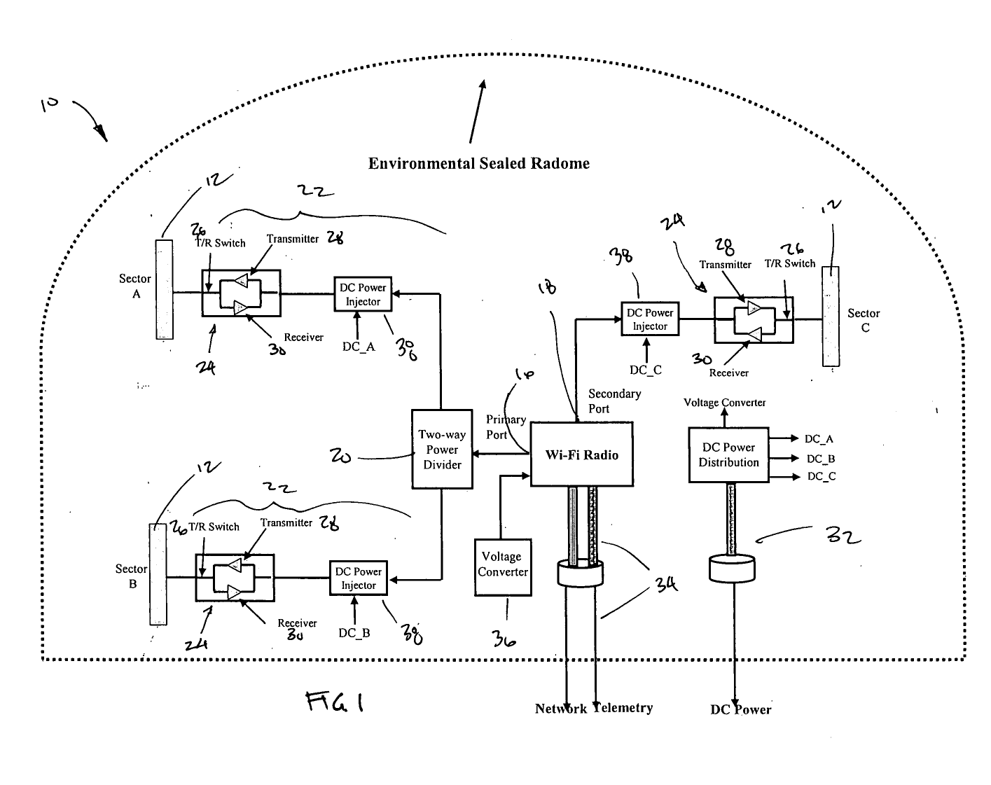

Referring to the drawings and, in particular, to FIG. 1 thereof, the wireless unlicensed band radio system of the present invention is provided and is referred to generally by reference numeral 10. The system 10 includes at least three sector antennas 12, each of which provides a minimum of 120 degrees of coverage at preferably a 3 decibel point. Each antenna 12 is aligned in the same plane and at a 120 angular separation from the other two, thereby providing 360 degrees of continuous coverage. It should be appreciated that the same coverage could also be provided by more than three antennas 12, with a lesser coverage required from each, or even by using only two antennas having 180 degrees of coverage. However, it has been observed that the use of three antennas is ideal in that it allows for ease of installation with a minimum of cabling and equipment being required, while allowing for continued operation of the radio system in the event of a failure of one of the antennas 12.

The antennas 12 are connected to a wireless unlicensed band radio 14. Since most commercially available unlicensed band radios 14 have only a primary RF port 16 and a secondary RF port 18 available to support transmit and receive operations, a passive two-way power divider 20 is incorporated in the primary RF port 16 in order to provide driving signals to two of the three antennas 12. The third antenna 12 is connected to the secondary RF port 18.

In order to improve performance of the communication link provided by the radio system 10, each antenna 12 includes a separate amplification path 20. A solid state transmit and receive amplification unit 24 is incorporated into each path 20. In addition to the amplification function, each unit 24 also has a built-in solid state switch 26 to toggle between the operation of a transmitter 28 and receiver 30. The logic for the switch 26 is provided by the unlicensed band radio 14. Unlike the conventional radio system, if there is a failure of one of the amplification units 24, such as if one of the amplification units is found to be defective, the entire communication link is not lost because the other two sector antennas 12 can still provide communication link with only a reduction in the angular coverage.

DC power and network connectivity are provided to the wireless radio system 10 by two separate sets of cables—power cables 32 and network cables 34. In the preferred embodiment, 10 the network cables 34 comprise two sets of CAT-5 cable for data and serial connections and the power cables 32 comprise a single pair of shielded 12 gauge wire for DC power. The CAT-5 cable was chosen because it does not have the distance limitation compared to the conventionally used coaxial cable. The specification for the CAT-5 cable is 100 meters, which is three times greater than the coaxial cable.

A voltage converter 36 is provided to supply the proper bias condition for the unlicensed band radio 14 and is connected thereto. Primary DC power is distributed by DC power distribution circuitry 38 to each individual amplification unit 24 and to the voltage converter 36. Power is directed to each amplification units 24 through a separate DC power injector 40 for each unit 24.

All of the sector antennas 12, amplification units 24, the unlicensed band radio 14 and the DC power conditioning circuitry 36, 38, 40 are all protected within an environmental sealed enclosure. In the preferred embodiment, said enclosure comprises a sealed radome 42. The radome offers protection against the harsh saltwater environment and direct solar loading, thus minimizing component failure due to saltwater exposure and excessive thermal stress .

Having thus described the invention with particular reference to the preferred forms thereof, it will be obvious that various changes and modifications can be made therein without departing from the spirit and scope of the present invention as defined by the appended claims.

1. A wireless unlicensed band radio system for use in maritime applications, said system comprising at least three sector antennas configured so as to provide continuous coverage in 360 degrees of rotation, said antennas each being connected to a wireless fidelity radio and serving to transmit and receive information from and to said radio.

2. The wireless radio architecture of claim 1, wherein each of said sector antennas provides a minimum of 120 degrees of coverage.

3. The wireless radio architecture of claim 2, wherein each of said antennas are configured at a 120 degree angular separation from the other two antennas.

4. The wireless radio architecture of claim 2, wherein said wireless unlicensed band radio includes a primary RF port and a secondary RF port, and further including a passive two-way power divider incorporated in said primary RF port.

5. The wireless radio architecture of claim 4, wherein two of said antennas are connected to said power divider and the third of said antennas is connected to said secondary RF port, wherein said power divider and said secondary RF port each provide driving signals to said antennas.

6. The wireless radio architecture of claim 2, wherein each of said antennas is connected to said wireless unlicensed band radio by a separate amplification path.

7. The wireless radio architecture of claim 6, further including a solid state transmit and receive amplification unit incorporated in each of said amplification paths.

8. The wireless radio architecture of claim 7, wherein said transmit and receive amplification units comprise a transmitter, a receiver and a solid state switch for selecting the operation of said transmitter and said receiver.

9. The wireless radio architecture of claim 8, further including a voltage converter to supply the proper bias condition for said wireless unlicensed band radio.

10. The wireless radio architecture of claim 9, further including power distribution circuitry, said circuitry directing DC power to said amplification units and said voltage converter.

11. The wireless radio architecture of claim 10, wherein said sector antennas, said amplification units, said wireless fidelity radio, and said power distribution circuitry are all enclosed within an environmentally sealed radome.

12. The wireless radio architecture of claim 11, wherein said wireless unlicensed band radio is connected to a network interface by means of two sets of CAT-5 cable.

13. The wireless radio architecture of claim 11, wherein said DC power is distributed to said amplification units and said voltage converter by a single pair of shielded 12 gauge wire.

14. A wireless radio architecture for use in maritime applications, said system comprising:
a wireless unlicensed band radio, wherein said wireless unlicensed band radio includes a primary RF port and a secondary RF port, and further including a passive two-way power divider incorporated in said primary RF port;
at least three sector antennas configured so as to provide continuous coverage in 360 degrees of rotation, wherein each of said sector antennas provides a minimum of 120 degrees of coverage, configured at a 120 degree angular separation from the other two antennas, said antennas each being connected to said wireless unlicensed band radio by a separate amplification path, wherein two of said antennas are connected to said power divider and the third of said antennas is connected to said secondary RF port, wherein a solid state transmit and receive amplification unit is incorporated in each of said amplification paths, said unit comprising a transmitter, a receiver and a solid state switch for selecting the operation of said transmitter and said receiver; and
an environmentally sealed radome within which said sector antennas, said amplification units and said wireless unlicensed band radio are enclosed and protected.
